(19) United States
(12) Patent Application Publication
(10) Pub. No.: US 2005/0045272 A1
(43) Pub. Date: Mar. 3, 2005

(54) Laser removal of adhesive

(75) Inventor: J. Kirk McGlothlan, Beaverton, OR (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/652,099

(22) Filed: Aug. 28, 2003

(51) Int. Cl. B32B 31/00

(52) U.S. Cl. 156/267; 156/272.8

(57) ABSTRACT

A method of making a drop emitting device that includes adhesively attaching an electrical circuit structure to a stainless steel substrate, and scanning a laser beam across adhesive that is extruded from between the stainless steel substrate and the electrical circuit structure so as to detach at least a portion of the adhesive from the stainless substrate.

### BACKGROUND OF THE DISCLOSURE

The subject disclosure is generally directed to laser removal of adhesive.

Drop on demand ink jet technology for producing printed media has been employed in commercial products such as printers, plotters, and facsimile machines. Generally, an ink jet image is formed by selective placement on a receiver surface of ink drops emitted by a plurality of drop generators implemented in a printhead or a printhead assembly. For example, the printhead assembly and the receiver surface are caused to move relative to each other, and drop generators are controlled to emit drops at appropriate times, for example by an appropriate controller. The receiver surface can be a transfer surface or a print medium such as paper. In the case of a transfer surface, the image printed thereon is subsequently transferred to an output print medium such as paper.

A known ink jet drop generator structure employs an electromechanical transducer that is adhesively attached to a diaphragm, and it can be difficult to remove excess adhesive extruded from between the diaphragm and the electromechanical transducer.

### BRIEF DESCRIPTION OF DRAWINGS

FIG. 1 is a schematic block diagram of an embodiment of a drop-on-demand drop emitting apparatus.

FIG. 2 is a schematic block diagram of an embodiment of a drop generator that can be employed in the drop emitting apparatus of FIG. 1.

FIG. 3 is a schematic elevational view of an embodiment of an ink jet printhead assembly.

FIG. 4 is a schematic plan view showing adhesive extruded from between a diaphragm layer and an electromechanical transducer layer of the ink jet printhead assembly of FIG. 3.

FIG. 5 schematically illustrates an example of scan paths that can be traced by a laser beam in removing adhesive from the diaphragm layer of the ink jet printhead assembly of FIG. 3.

FIG. 6 schematically illustrates another example of scan paths that can be traced by a laser beam in removing adhesive from the diaphragm layer of the ink jet printhead assembly of FIG. 3.

### DETAILED DESCRIPTION OF THE DISCLOSURE

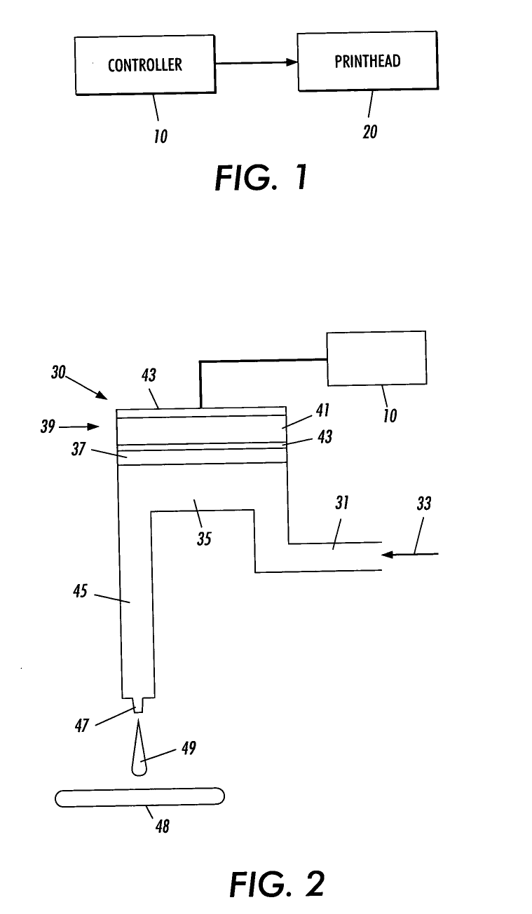

FIG. 1 is a schematic block diagram of an embodiment of a drop-on-demand printing apparatus that includes a controller 10 and a printhead assembly 20 that can include a plurality of drop emitting drop generators. The controller 10 selectively energizes the drop generators by providing a respective drive signal to each drop generator. Each of the drop generators can employ a piezoelectric transducer such as a ceramic piezoelectric transducer. As other examples, each of the drop generators can employ a shear-mode transducer, an annular constrictive transducer, an electrostrictive transducer, an electromagnetic transducer, or a magnetorestrictive transducer. The printhead assembly 20 can be formed of a stack of laminated sheets or plates, such as of stainless steel.

FIG. 2 is a schematic block diagram of an embodiment of a drop generator 30 that can be employed in the printhead assembly 20 of the printing apparatus shown in FIG. 1. The drop generator 30 includes an inlet channel 31 that receives ink 33 from a manifold, reservoir or other ink containing structure. The ink 33 flows into a pressure or pump chamber 35 that is bounded on one side, for example, by a flexible diaphragm 37. An electromechanical transducer 39 is attached to the flexible diaphragm 37 and can overlie the pressure chamber 35, for example. The electromechanical transducer 39 can be a piezoelectric transducer that includes a piezo element 41 disposed for example between electrodes 43 that receive drop firing and non-firing signals from the controller 10. Actuation of the electromechanical transducer 39 causes ink to flow from the pressure chamber 35 to a drop forming outlet channel 45, from which an ink drop 49 is emitted toward a receiver medium 48 that can be a transfer surface, for example. The outlet channel 45 can include a nozzle or orifice 47.

The ink 33 can be melted or phase changed solid ink, and the electromechanical transducer 39 can be a piezoelectric transducer that is operated in a bending mode, for example.

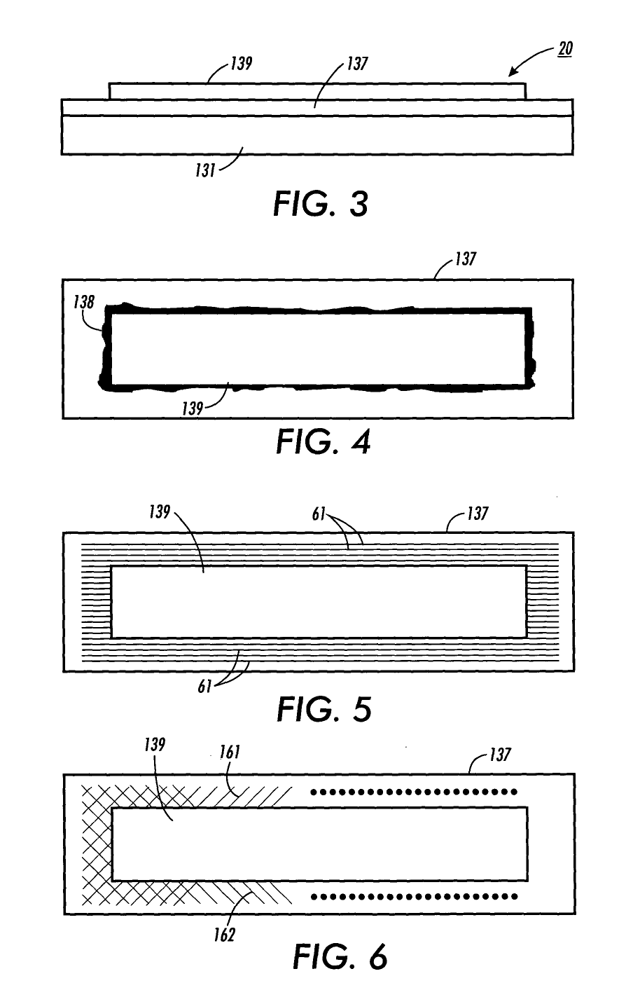

FIG. 3 is a schematic elevational view of an embodiment of an ink jet printhead assembly 20 that can implement a plurality of drop generators 30 (FIG. 2), for example as an array of drop generators. The ink jet printhead assembly includes a fluid channel layer or substructure 131, a diaphragm layer 137 attached to the fluid channel layer 131, and transducer layer 139 attached to the diaphragm layer 137. The fluid channel layer 131 implements the fluid channels and chambers of the drop generators 30, while the diaphragm layer 137 implements the diaphragms 37 of the drop generators. The transducer layer 139 implements the electromechanical transducers 39 of the drop generators 30.

By way of illustrative example, the diaphragm layer 137 comprises a metal plate or sheet such as stainless steel that is attached or bonded to the fluid channel layer 131. Also by way of illustrative example, the fluid channel layer 131 can comprise multiple laminated plates or sheets. The transducer layer 139 can comprise an array of kerfed ceramic transducers that are attached or bonded to the diaphragm layer 137, for example with a polymeric adhesive or sealant such as a filled or unfilled epoxy, silicone, or neopene based composition. A filler for an adhesive may be organic, ceramic or metallic, for example.

The fluid channel layer 131 can have a width in the range of about 0.5 inches to about 12 inches, and a length in the range of about 0.5 inches to about 12 inches. The transducer layer 139 can have a width in the range of about 0.25 inches to about 11.75 inches, and a length in the range of about 0.25 inches to about 11.75 inches.

The transducer layer 139 can more particularly be bonded to the diaphragm layer 137 by applying a suitable adhesive to the diaphragm layer and/or the transducer layer, and then pressing the transducer layer against the diaphragm layer. Excess adhesive 138 is extruded from between the transducer layer 139 and the diaphragm layer 137, and forms, for example, adhesive ridges or beads on the diaphragm layer 137 around the perimeter of the transducer layer 139, as schematically depicted in FIG. 4. At least a portion of the extruded adhesive 138 can be substantially detached from the diaphragm layer 139 by stepwise scanning a pulsed laser beam across the adhesive ridges or beads. The detached adhesive can be removed by an air evacuation system, for example.

By way of illustrative example, an Nd:YAG laser or an Nd:Vanadate laser can be employed, for example at a pulse frequency in a range of about 20 KHz to about 25 KHz, a scan speed of about 1000 mm per second, and a fill distance or pitch between adjacent scans of about 0.1 mm. As another example, the laser can be operated at a pulse frequency of about 10 KHz and a scan speed in the range of about 400 mm per second to about 600 mm per second. The laser can also be operated at a pulse frequency of about 35 KHz and a scan speed in the range of about 1200 mm per second to about 1600 mm per second. More generally, the laser can be operated at a pulse frequency in the range of about 5 KHz to about 35 KHz and a scan speed in the range of about 300 mm per second to about 1600 mm per second. An excimer laser can also be employed.

As schematically depicted in FIG. 5, which for clarity does not show the extruded adhesive 138 (FIG. 4), the scan paths of the laser beam can comprise a plurality of substantially parallel scan paths 61. The substantially parallel scan paths 61 can be overlapping or non-overlapping.

As schematically depicted in FIG. 6, which for clarity does not show the extruded adhesive 138 (FIG. 4), the scan paths of the laser beam can alternatively comprise a first plurality of substantially parallel paths 161 and a second plurality of substantially parallel paths 162 that are not parallel to the first plurality of scan paths 161. For example the second scan paths 162 can be at about 90 degrees to the first scan paths 161. The first substantially parallel scan paths 161 can be overlapping or non-overlapping. Similarly, the second substantially parallel scan paths 162 can be overlapping or non-overlapping.

This disclosure thus generally contemplates detaching adhesive from a substrate by scanning a pulsed laser beam across the region that contains the adhesive. The adhesive to be detached can be adhesive extruded by adhesive attachment of an electrical circuit structure such as an array of electromechanical transducers, an integrated circuit or a circuit board to a substrate.

The invention has been described with reference to disclosed embodiments, and it will be appreciated that variations and modifications can be affected within the spirit and scope of the invention.

1. A method of making a drop emitting device comprising:
attaching a stainless steel diaphragm layer to a fluid channel layer comprising a stack of stainless steel plates;
adhesively attaching a piezoelectric transducer layer to the stainless steel diaphragm layer; and
scanning a pulsed laser beam across adhesive that is extruded from between the stainless steel diaphragm layer and the piezoelectric transducer layer, so as to detach at a least a portion of the extruded adhesive from the stainless steel diaphragm layer.

2. The method of claim 1 wherein the fluid channel layer has a width in the range of about 0.5 inches to about 12 inches and a length in the range of about 0.5 inches to about 12 inches.

3. The method of claim 1 wherein scanning a pulsed laser beam comprises scanning an Nd:YAG pulsed laser beam across adhesive that is extruded from between the stainless steel diaphragm layer and the piezoelectric transducer layer, so as to detach at a least a portion of the extruded adhesive from the metal diaphragm layer.

4. The method of claim 1 wherein adhesively attaching comprises adhesively attaching a piezoelectric transducer layer to the stainless steel diaphragm layer with an epoxy based adhesive.

5. The method of claim 1 wherein adhesively attaching comprises adhesively attaching a piezoelectric transducer layer to the stainless steel diaphragm layer with a polymeric adhesive.

6. The method of claim 1 wherein adhesively attaching comprises adhesively attaching a piezoelectric transducer layer to the stainless steel diaphragm layer with a filled polymeric adhesive.

7. The method of claim 1 wherein scanning a pulsed laser beam comprises scanning a pulsed laser beam having a pulse frequency in the range of about 5 KHz to about 30 KHz and at a scan speed in the range of about 300 mm per second to about 1600 mm per second across adhesive that is extruded from between the stainless steel diaphragm layer and the piezoelectric transducer layer, so as to detach at a least a portion of the adhesive from the stainless steel diaphragm layer.

8. The method of claim 1 wherein scanning a pulsed laser beam comprises scanning a pulsed laser beam having a frequency in the range of about 20 KHz to about 25 KHz and at a scan speed of about 1000 mm per second across adhesive that is extruded from between the stainless steel diaphragm layer and the piezoelectric transducer layer, so as to detach at a least a portion of the extruded adhesive from the stainless steel diaphragm layer.

9. The method of claim 1 wherein scanning a pulsed laser beam comprises scanning a pulsed laser beam at a scan speed of about 1000 mm per second across adhesive that is extruded from between the stainless steel diaphragm layer and the piezoelectric transducer layer, so as to detach at a least a portion of the extruded adhesive from the stainless steel diaphragm layer.

10. The method of claim 1 wherein scanning a pulsed laser beam comprises scanning a pulsed laser beam along substantially parallel non-overlapping scan paths across adhesive that is extruded from between the stainless steel diaphragm layer and the piezoelectric transducer layer, so as to detach at a least a portion of the extruded adhesive from the stainless steel diaphragm layer.

11. The method of claim 1 wherein scanning a pulsed laser beam comprises scanning a pulsed laser beam along substantially parallel scan paths having a pitch of about 0.1 mm across adhesive that is extruded from between the stainless steel diaphragm layer and the piezoelectric transducer layer, so as to detach at a least a portion of the extruded adhesive from the stainless steel diaphragm layer.

12. A drop emitting device made in accordance with the method of claim 1.

13. A method of making a drop emitting device comprising:
attaching a stainless steel diaphragm layer to a fluid channel layer;
adhesively attaching an electrical circuit structure to the stainless steel diaphragm layer; and
scanning a laser beam across adhesive that is extruded from between the stainless steel diaphragm layer and the electrical circuit structure, so as to detach at least a portion of the extruded adhesive from the stainless steel diaphragm layer.

14. The method of claim 13 wherein the fluid channel layer has a width in the range of about 0.5 inches to about 12 inches and a length in the range of about 0.5 inches to about 12 inches.

15. The method of claim 13 wherein scanning a pulsed laser beam comprises scanning an Nd:YAG pulsed laser beam across adhesive that is extruded from between the stainless steel diaphragm layer and the electrical circuit structure, so as to detach at a least a portion of the extruded adhesive from the stainless steel diaphragm layer.

16. The method of claim 13 wherein adhesively attaching comprises adhesively attaching an electrical circuit to the stainless steel diaphragm layer with an epoxy based adhesive.

17. The method of claim 13 wherein adhesively attaching comprises adhesively attaching an electrical circuit to the stainless steel diaphragm layer with a polymeric adhesive.

18. The method of claim 13 wherein adhesively attaching comprises adhesively attaching an electrical circuit to the stainless steel diaphragm layer with a filled polymeric adhesive.

19. The method of claim 13 wherein scanning a pulsed laser beam comprises scanning a pulsed laser beam having a pulse frequency in the range of about 5 KHz to about 30 KHz and at a scan speed in the range of about 300 mm per second to about 1600 mm per second across adhesive that is extruded from between the stainless steel diaphragm layer and the electrical circuit structure, so as to detach at a least a portion of the extruded adhesive from the stainless steel diaphragm layer.

20. The method of claim 13 wherein scanning a pulsed laser beam comprises scanning a pulsed laser beam having a frequency in the range of about 20 KHz to about 25 KHz and at a scan speed of about 1000 mm per second across adhesive that is extruded from between the stainless steel diaphragm layer and the electrical circuit structure, so as to detach at a least a portion of the extruded adhesive from the stainless steel diaphragm layer.

21. The method of claim 13 wherein scanning a pulsed laser beam comprises scanning a pulsed laser beam at a scan speed of about 1000 mm per second across adhesive that is extruded from between the stainless steel diaphragm layer and the electrical circuit structure, so as to detach at a least a portion of the extruded adhesive from the stainless steel diaphragm layer.

22. The method of claim 13 wherein scanning a pulsed laser beam comprises scanning a pulsed laser beam along substantially parallel non-overlapping scan paths across adhesive that is extruded from between the stainless steel diaphragm layer and the electrical circuit structure, so as to detach at a least a portion of the extruded adhesive from the stainless steel diaphragm layer.

23. The method of claim 13 wherein scanning a pulsed laser beam comprises scanning a pulsed laser beam along substantially parallel scan paths having a pitch of about 0.1 mm across adhesive that is extruded from between the stainless steel diaphragm layer and the electrical circuit structure, so as to detach at a least a portion of the extruded adhesive from the stainless steel diaphragm layer.

24. A drop emitting device made in accordance with the method of claim 13.
